(19) United States
(12) Patent Application Publication
(10) Pub. No.: US 2004/0202070 A1
(43) Pub. Date: Oct. 14, 2004

(54) Apparatus and method for generating tracking error signal and optical recording/reproducing system using same

(75) Inventors: Kyoung-hwan Park, Suwon-si (KR); Eun-goo Kim, Suwon-si (KR); Pyong-yong Seong, Seoul (KR); Chul-ho Jeon, Suwon-el (KR)

Correspondence Address: STAAS & HALSEY LLP, SUITE 700, 1201 NEW YORK AVENUE, N.W., WASHINGTON, DC, 20005, US

(73) Assignee: SAMSUNG Electronics Co., Ltd., Suwon-city (KR)

(21) Appl. No.: 10/678,750

(22) Filed: Oct. 3, 2003

(30) Foreign Application Priority Data
Oct. 8, 2002 (KR) 2002-61219

(51) Int. Cl. G11B 7/085

(52) U.S. Cl. 369/44.37; 369/44.41; 369/53.23

(57) ABSTRACT

Provided are an apparatus and method for stably generating a tracking error signal in an optical recording/reading system irrespective of a disc track pitch. The apparatus includes a main beam push pull (MPP) signal generating unit which generates an MPP signal according to electrical signals output by main photodetecting units based on a calculated difference of beam powers detected by the main photodetecting units arranged on right and left sides of a specific track, respectively, a side beam push pull (SPP) signal generating unit which generates an SPP signal according to electrical signals output by photodetecting units based on a calculated difference of beam powers detected by the photodetecting units, the photdetecting units being one of pairs of the main photodetecting units diagonally arranged with respect to the track and side photodetecting units disposed on opposing sides of the track and outside of the main photdetecting units, a filter which removes AC components from the SPP signal; and a subtractor which generates a tracking error signal by calculating a difference between the MPP signal and the filtered SPP signal.

### CROSS-REFERENCE TO RELATED APPLICATIONS

This application claims the priority of Korean Patent Application No. 2002-61219 filed Oct. 8, 2002, in the Korean Intellectual Property Office, the disclosure of which is incorporated herein in its entirety by reference.

### BACKGROUND OF THE INVENTION

1. Field of the Invention

The present invention relates to an apparatus and method for controlling an optical recording/reproducing system, and more particularly, to an apparatus and method for stably generating a tracking error signal regardless of a track pitch distance of a disc.

2. Description of the Related Art

In general, an optical recording/reproducing system records data on recording media such as a digital versatile disc (DVD) by forming pits thereon using a laser beam and obtains a reproduction signal by processing light reflected from a disc surface on which pits are recorded.

The optical recording/reproducing system performs a focus control in which a beam is focused on the disc surface by moving a pickup in a vertical direction, and performs a tracking control in which a beam follows a desired track by moving the pickup in a horizontal direction.

In general, for the tracking control, a tracking error signal is generated using a three-beam method, a push-pull method, a differential push pull (DPP) method, or the like. In general, the three-beam method is applied to CD players and the DPP method is applied to CD-R/Ws.

Photodetecting units in a pickup of an optical recording/reproducing system may be positioned such that four main beam spots are focused as illustrated in FIG. 1A. Otherwise, the photodetecting units may be positioned such that a pair of tracking side beams are focused before and after main beam spots for decoding information, as illustrated in FIG. 1B. More specifically, the photodetecting units of FIG. 1B are positioned to focus the side beams in the right and left directions with respect to a track, more particularly, at half of the position of a track pitch.

A method of generating a tracking error signal (or a DPP signal) using photodetecting units PD_{A}, PD_{B}, PD_{C}, PD_{D}, PD_{E}, and PD_{F} corresponding to the spots of FIG. 1B and the DPP method will now be explained.

First, a main beam push-pull (MPP) signal is obtained by performing an operation on electrical signals a, b, c, and d output by the main photodetecting units PD_{A}, PD_{B}, PD_{C}, and PD_{D}, respectively, using the following equation:

MPP=(a+d)−(b+c) (1)

Next, a side beam push-pull (SPP) signal is obtained by performing an operation on electrical signals e and f output from the side photodetecting units PD_{E} and PD_{F}, respectively, using the following equation:

SPP=e−f (2)

Thereafter, a tracking error signal (or a DPP signal) is obtained using the following equation:

DPP=MPP−SPP (3)

It is known that a DC offset in the MPP signal is prone to being generated when shifting a lens. To prevent the occurrence of the DC offset, the DPP signal is produced by multiplying the SPP signal by a specific gain value k and subtracting the multiplication result from the MPP signal.

Nonetheless, a change in a disc track pitch makes it difficult to precisely match the phases of the MPP signal and the SPP signal, thereby preventing stable generation of the DPP signal.

FIG. 2A illustrates a main beam spot and side beam spots detected by photodetecting units when a disc track pitch is formed to a desired level with respect to a pickup that detects a DPP signal. FIG. 2B illustrates a main beam spot and side beam spots detected by the photodetecting units when a disc track pitch is narrower than the desired level with respect to the pickup. FIG. 2C illustrates a main beam spot and side beam spots detected by the photodetecting units when a disc track pitch is wider than the desired level with respect to the pickup.

FIGS. 3A, 3B, and 3C illustrate waveforms of an MPP signal, an SPP signal, and a DPP signal, respectively, when a disc track pitch is formed to a desired level as illustrated in FIG. 2A. FIGS. 4A, 4B, and 4C illustrate waveforms of an MPP signal, an SPP signal, and a DPP signal, respectively, when a disc track pitch is narrower than the desired level as illustrated in FIG. 2B. FIGS. 5A, 5B, and 5C illustrate waveforms of an MPP signal, an SPP signal, and a DPP signal, respectively, when a disc track pitch is wider than the desired level as illustrated in FIG. 2C.

As illustrated in FIGS. 3A through 5, a change in a disc track pitch results in a difference between the phases of the MPP signal and the SPP signal, thereby preventing stable generation of the DPP signal.

To solve this problem, Korean Laid-Open Patent Publication No. 2002-42200 suggests compensating for a difference between the phases of a MPP signal and an SPP signal by changing a gain value k. However, for the compensation, a circuit that detects a phase difference between the MPP signal and the SPP signal, and a circuit that changes a gain value k based on the detected phase difference are required to be additionally installed in an optical recording/reproducing system. The installation of these circuits, however, complicates a circuit structure of the optical recording/reading system and increases manufacturing costs.

### SUMMARY OF THE INVENTION

The present invention provides an apparatus and method for stably generating a tracking error signal (or a DPP signal) irrespective of a change in a disc track pitch without complicating the structure of an optical recording/reproducing system, thereby performing a stable servo control.

Additional aspects and/or advantages of the invention will be set forth in part in the description which follows and, in part, will be obvious from the description, or may be learned by practice of the invention.

According to an aspect of the present invention, there is provided a tracking error signal generating apparatus used in an optical recording/reproducing system, the apparatus comprising: a main beam push pull (MPP) signal generating unit that generates an MPP signal using electrical signals detected by main photodetecting units and calculating a deviation of beam powers detected by the photodetecting units that are arranged in the right and left directions with respect to a specific track; a side beam push pull (SPP) signal generating unit that generates an SPP signal using electrical signals detected by the photodetecting units and calculating a deviation of beam powers detected by the photodetecting units that are arranged in a diagonal direction with respect to the specific track; a filter that removes AC components from the SPP signal; and a subtractor that generates a tracking error signal by calculating a difference between the MPP signal and the SPP signal whose AC components are removed by the filter.

According to another aspect of the present invention, there is provided a method of generating a tracking error signal in an optical recording/reproducing system, wherein the tracking error signal is generated by calculating a difference between an MPP signal and an SPP signal whose AC components are removed, the MPP signal being obtained by calculating a deviation of beam powers detected by photodetecting units that are arranged in the right and left directions with respect to a specific track and the SPP signal being obtained by calculating a deviation of beam powers detected by photodetecting units that are arranged in a diagonal direction with respect to the specific track.

According to still another aspect of the present invention, there is provided an optical recording/reproducing system, including: a pickup which emits a laser beam toward an optical medium and detects a reflected laser beam reflected from a disc; a tracking error signal generating unit that generates a tracking error signal by calculating a difference between an MPP signal obtained by calculating a deviation of beam powers detected by main photodetecting units which are arranged in right and left directions with respect to a track and an SPP signal obtained by calculating a deviation of beam powers detected by photodetecting units which are one of main photodetecting units diagonally arranged with respect to the track and signals output by side photodetecting units disposed on opposing sides of the main photodetectors; a servo controller which generates a tracking driving signal which is used to move an optical system of the pickup in a radial direction so as to direct the laser beam at a center of the track, using the tracking error signal; and a tracking servo driving unit which drives a tracking actuator included in the pickup in response to the tracking driving signal.

According to yet another aspect of the present invention, there is provided a computer readable medium encoded with processing instructions for implementing a method of generating a tracking error signal. The method includes calculating a difference between an MPP signal and an SPP signal whose AC components are removed. The MPP signal is obtained by calculating a deviation of beam powers detected by main photodetecting units which are arranged in right and left directions with respect to a track and the SPP signal is obtained by calculating a deviation of beam powers detected by photodetecting units which are one of pairs of the main photodetectors diagonally arranged with respect to the track and side photodecting units disposed on opposing sides of the track and outside of the main photodetecting units.

According to yet another aspect of the present invention, there is provided a tracking error signal generator including: a main push pull (MPP) signal generator which generates an MPP signal based on a difference between a first sum signal representing the sum of signals output from main photodetecting portions disposed on a side of a track and a second sum signal representing the sum of signals output by the main photodetecting portions disposed on an opposing side of the track; a side push pull (SPP) signal generator which generates an SPP signal based on a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a fifth signal output by a first side photodetector and a sixth signal output by a second side photodetector; a filter which removes one or more AC components from the SPP signal; and a subtractor which generates a tracking error signal based on a difference between the MPP signal and a filtered SPP signal.

According to yet another aspect of the present invention, there is provided a method of generating a tracking error signal, including: generating a main push pull (MPP) signal based on a difference between a first sum signal representing the sum of signals output from main photodetecting portions disposed on a side of a track and a second sum signal representing the sum of signals output by the main photodetecting portions disposed on an opposing side of the track; generating a side push pull (SPP) a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a firth sum signal output by a first side photodetector and a sixth sum signal output by a second side photodetector; removing one or more AC components from the SPP signal; and generating a tracking error signal based on a difference between the MPP signal and a filtered SPP signal.

According to yet another aspect of the present invention, there is provided a computer readable medium encoded with processing instructions for implementing a method of generating a tracking error signal. The method includes: generating a main push pull (MPP) signal based on a difference between a first sum signal representing the sum of signals output from main photodetecting portions disposed on a side of a track and a second sum signal representing the sum of signals output by the main photodetecting portions disposed on an opposing side of the track; generating a side push pull (SPP) signal based on a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a fifth signal output by a first side photodetector and a sixth signal output by a second side photodetector; removing one or more AC components from the SPP signal; and generating a tracking error signal based on a difference between the MPP signal and a filtered SPP signal.

According to yet another aspect of the present invention, there is provided an optical recording/reproducing system, including: a pickup having a light beam generator which generates a light beam, an optical system which focuses the light beam onto an optical medium, a focus/tracking actuator which moves the optical system in a radial direction with respect to the optical medium in response to a tracking driving signal so as to direct the light beam at a specific track on the optical medium, and a photodetector section including main photodetecting portions which receive the light beam after the light beam is reflected from the optical medium and output respective signals in response thereto; a tracking error signal generator which generates a tracking error signal representing a difference between a main push pull (MPP) signal and a side push pull (SPP) generator; and a servo controller which generates the tracking driving signal based on the tracking error signal. The MPP signal is generated based on a difference between a first sum signal representing the sum of signals output from main photodetecting portions disposed on a side of a track and a second sum signal representing the sum of signals output by the main photodetecting portions disposed on an opposing side of the track. The SPP signal is generated based on a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a fifth signal output by a first side photodetector and a sixth signal output by a second side photodetector.

According to yet another aspect of the present invention, there is provided a filter in a tracking error signal generating circuit which generates a tracking error signal using a differential push pull method, including an AC component remover which removes one or more AC components from a side beam push pull (SPP) signal. The SPP signal is obtained by using electrical signals output by photodetecting units based on a calculated deviation of beam powers detected by the photodetecting units, the photodetecting units being one of pairs of the main photodetecting units diagonally arranged with respect to the track and side photodetecting units disposed on opposing sides of the track and outside of the main photdetecting units. The tracking error signal can be stably generated regardless of a disc track pitch.

### BRIEF DESCRIPTION OF THE DRAWINGS

These and/or other aspects and advantages of the invention will become apparent and more readily appreciated from the following description of the preferred embodiments taken in conjunction with the accompanying drawings in which:

FIG. 1 illustrates an arrangement of a photodetector;

FIG. 2A illustrates a main beam spot and side beam spots detected by the photodetector of FIG. 1 when a disc track pitch is formed to a desired level with respect to a pickup that detects a tracking error signal (or a DPP signal);

FIG. 2B illustrates a main beam spot and side beam spots detected by the photodetector of FIG. 1 when a disc track pitch is narrower that a desired level with respect to a pickup that detects a DPP signal;

FIG. 2C illustrates a main beam spot and side beam spots detected by the photodetector of FIG. 1 when a disc track pitch is wider than a desired level with respect to a pickup that detects a DPP signal;

FIGS. 3A, 3B, and 3C illustrate waveforms of a main beam push-pull (MPP) signal, a side beam push-pull (SPP) signal, and a DPP signal, respectively, generated using the detection results of the photodetector of FIG. 1 when a disc track pitch is formed to a desired level;

FIGS. 4A, 4B, and 4C illustrate waveforms of an MPP signal, an SPP signal, and a DPP signal, respectively, generated using the detection results of the photodetector of FIG. 1 when a disc track pitch is narrower than a desired level;

FIGS. 5A, 5B, and 5C illustrate waveforms of an MPP signal, an SPP signal, and a DPP signal, respectively, generated using the detection results of the photodetector of FIG. 1 when a disc track pitch is wider than a desired level;

FIG. 6 is a block diagram illustrating the structure of an optical recording/reproducing apparatus according to an embodiment of the present invention;

FIG. 7 is a block diagram of a DPP signal generating apparatus according to an embodiment of the present invention;

FIG. 8 illustrates waveforms of a DPP signal, an MPP signal, and an SPP signal generated by a tracking error signal generating circuit included in an optical recording/reproducing system according to an embodiment of the present invention; and

FIG. 9 illustrates waveforms of a DPP signal, an MPP signal, and an SPP signal generated by a conventional tracking error signal generating apparatus included in an optical recording/reproducing system.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

Referring to FIG. 6, an optical recording/reproducing system according to an embodiment of the present invention includes a pickup 602, an RF & servo error signal generating unit 603, a servo controller 604, a focus servo driving unit 605, a tracking servo driving unit 606, a sled servo driving unit 607, and a sled motor 608. The optical recording/reproducing system writes to and reads from an optical disk 601.

Although not shown in the drawings, the pickup 602 includes a laser diode, a photodetector, an optical system with various types of lenses, and a focus/tracking actuator. The servo controller 604 performs tracking and focus controls so that a beam condensed by an objective lens (not shown) is positioned at a desired track of the optical disc 601. Then, the beam is reflected from a recording surface of the optical disc 601, condensed again by the objective lens, and incident upon the photodetector so as to detect a focus error signal and a tracking error signal.

The photodetector includes a plurality of photodetecting units and outputs electrical signals corresponding to the power of the beams respectively detected by the respective photodetecting units to the RF & servo error signal generating unit 603.

The RF & servo error signal generating unit 603 generates an RF signal for data reproduction, a focus error signal FE, and a tracking error signal TE for servo control, using electrical signals respectively output from the respective photodetecting units of the photodetector.

The generated RF signal is output from a data decoder (not shown) and the focus error signal FE and the tracking error signal TE are input to the servo controller 604.

The servo controller 604 processes the focus error signal FE to generate a driving signal for focus control and outputs the driving signal to the focus servo driving unit 605. Also, the servo controller 604 processes the tracking error signal TE to generate a driving signal for tracking control and outputs the driving signal to the tracking servo driving unit 606.

The focus servo driving unit 605 drives the focus actuator included in the pickup 602 to move the pickup 602 along a vertical axis with respect to the surface of the optical disc 601. Such a movement of the pickup 602 focuses a beam on a disc surface of the optical disc 601 while rotating the optical disc 601.

The tracking servo driving unit 606 moves the objective lens of the pickup 602 along a horizontal direction substantially parallel to the surface of the optical disc 601 to make a beam follow a desired track of the optical disc 601.

In order to move the pickup 602 to a desired position, the sled servo driving unit 607 receives a sled control signal from the servo controller 604 and drives the sled motor 608 to move the pickup 602 to the desired position.

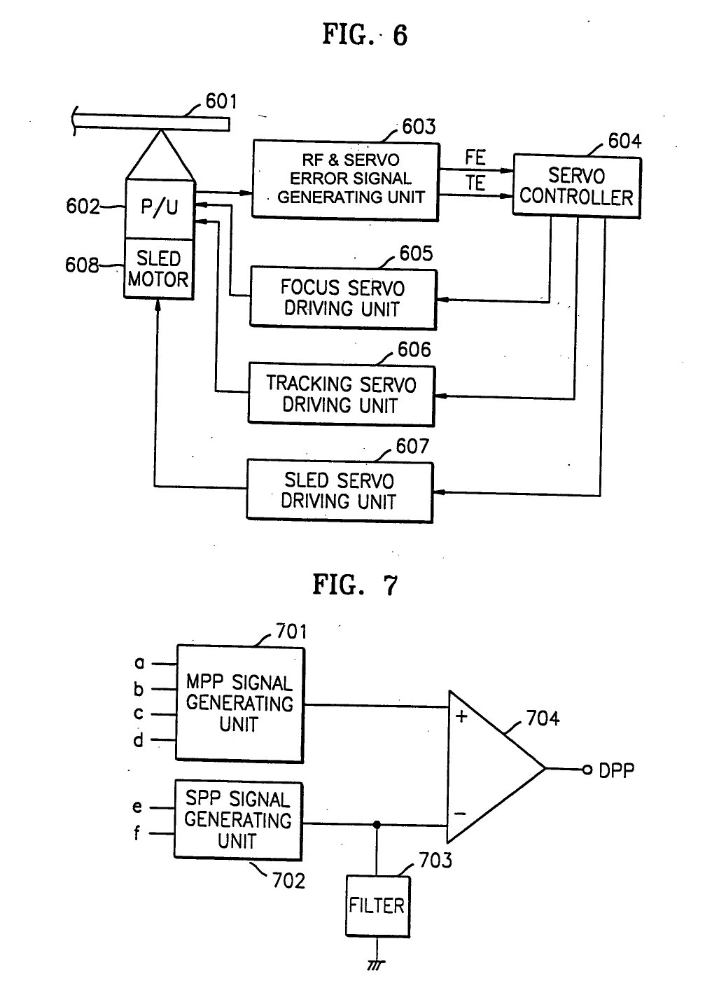

The RF & servo error signal generating unit 603 includes a tracking error signal generating circuit as shown in FIG. 7. Referring to FIG. 7, a tracking error signal generating circuit according to an embodiment of the present invention includes a main beam push pull (MPP) signal generating unit 701, a side beam push pull (SPP) signal generating unit 702, a filter 703, and a subtractor 704.

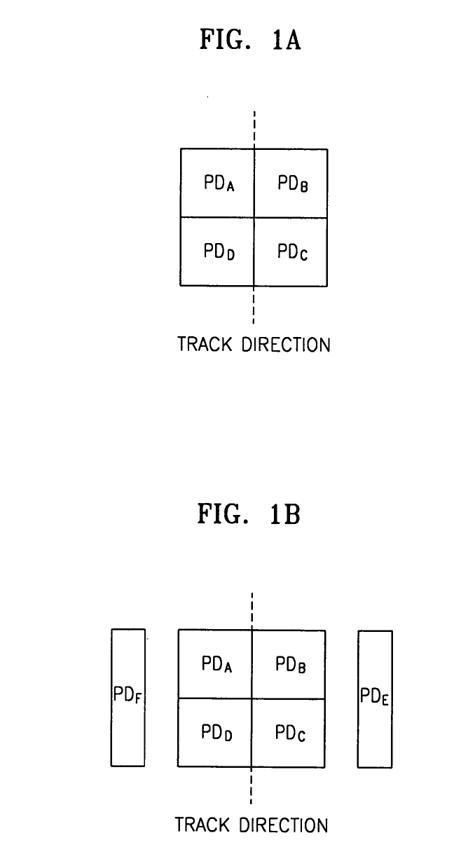

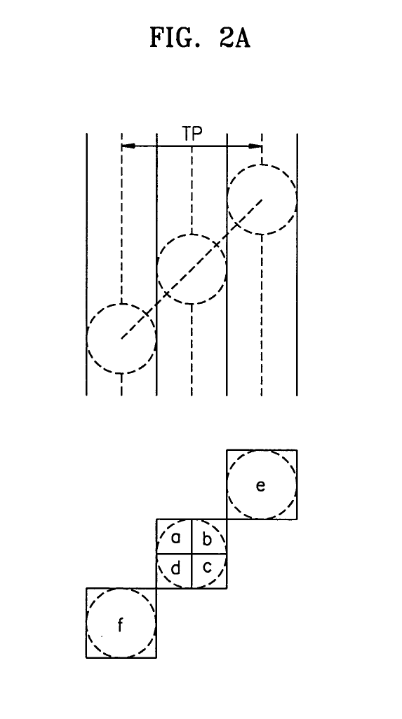

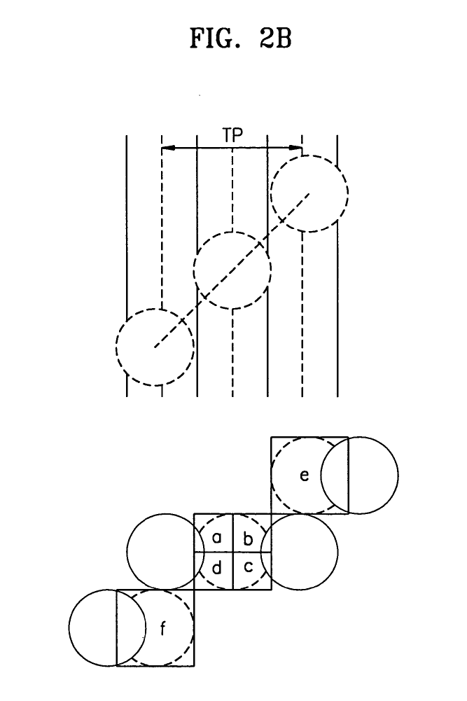

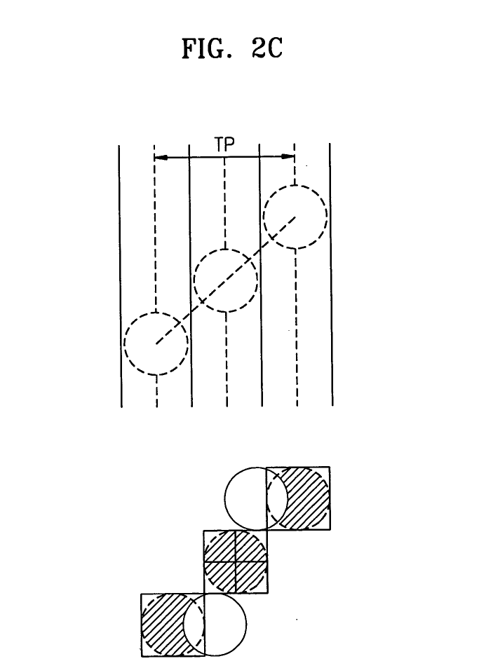

The photodetector in the pickup 602 has a structure as explained with reference to FIG. 1B. However, it is to be understood that the structure of the photodetector may differ from the structure illustrated in FIG. 1B.

As shown in FIG. 1B, main photodetecting units PD_{A}, PD_{B}, PD_{C}, and PD_{D} are positioned at four quadrants in a clockwise direction and the photodetecting units PD_{A} and PD_{D} are arranged to be symmetrical with the photodetecting units PD_{B} and PD_{C}, with respect to a specific track. Further, side photodetecting units PD_{E} and PD_{F} are positioned to the right and left of the main photodetecting units PD_{A}, PD_{B}, PD_{C}, and PD_{D} with respect to the specific track. If electrical signals detected by the photodetecting units PD_{A}, PD_{B}, PD_{C}, PD_{D}, PD_{E}, and PD_{F} are a, b, c, d, e, and f, an MPP signal generating unit 701 of FIG. 7 calculates a signal (a+d)−(b+c) to generate an MPP signal and an SPP signal generating unit 702 calculates a signal (e−f) to generate an SPP signal.

Referring to FIG. 7, a filter 703 is connected to an output terminal of the SPP signal generating unit 702 and removes an AC signal component from the SPP signal. As a result, only DC components of the SPP signal are input to a subtractor 704. That is, the filter 703 is designed to have high-pass filtering characteristics or band-pass filtering characteristics. However, when the filter 703 is positioned in series between the SPP signal generating unit 702 and the subtractor 704, the filter 703 is designed to have low-pass filtering characteristics.

Next, the subtractor 704 receives the MPP signal generated by the MPP signal generating unit 701 and the SPP signal generated by the SPP signal generating unit 702 with the AC components removed by the filter 703, and generates a differential push pull (DPP) signal (or a tracking error signal) that is a difference signal between the MPP signal and the SPP signal whose AC components are removed.

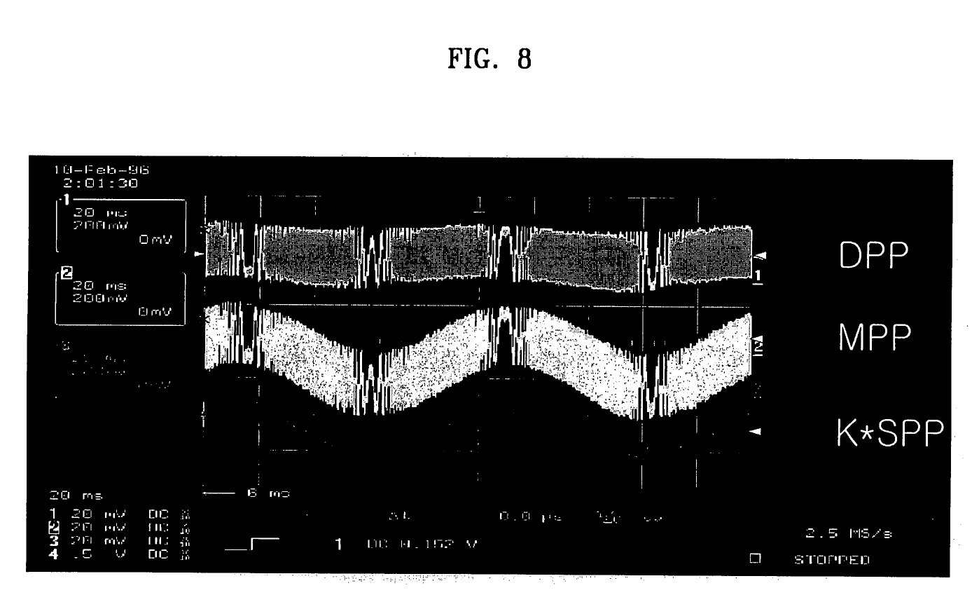

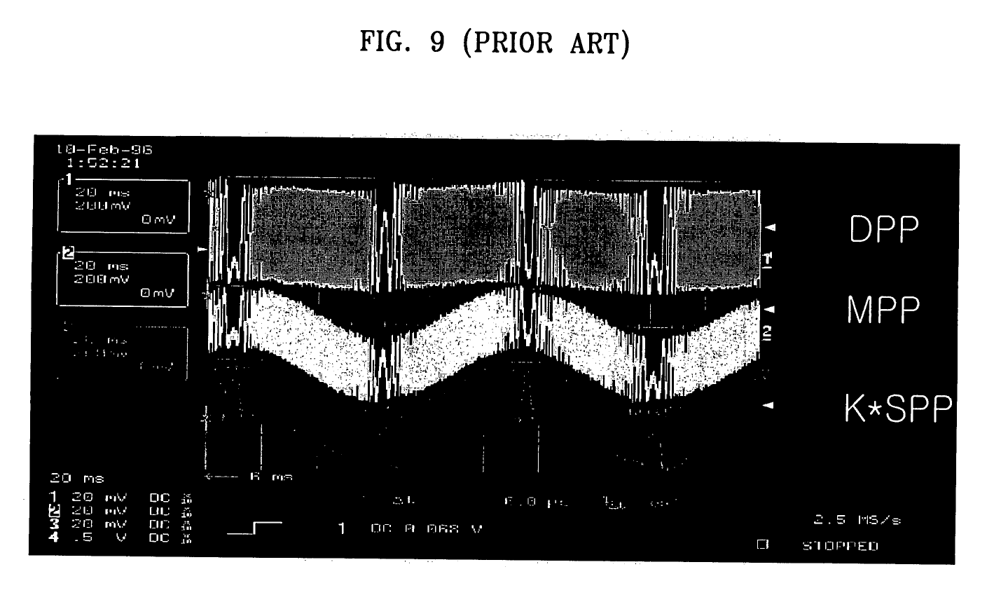

FIG. 8 illustrates waveforms of a DPP signal, an MPP signal, and an SPP signal generated by a tracking error signal generating circuit included in an optical recording/reproducing system according to an embodiment of the present invention. FIG. 9 illustrates waveforms of a DPP signal, an MPP signal, and an SPP signal generated by a conventional tracking error signal generating apparatus included in an optical recording/reproducing system.

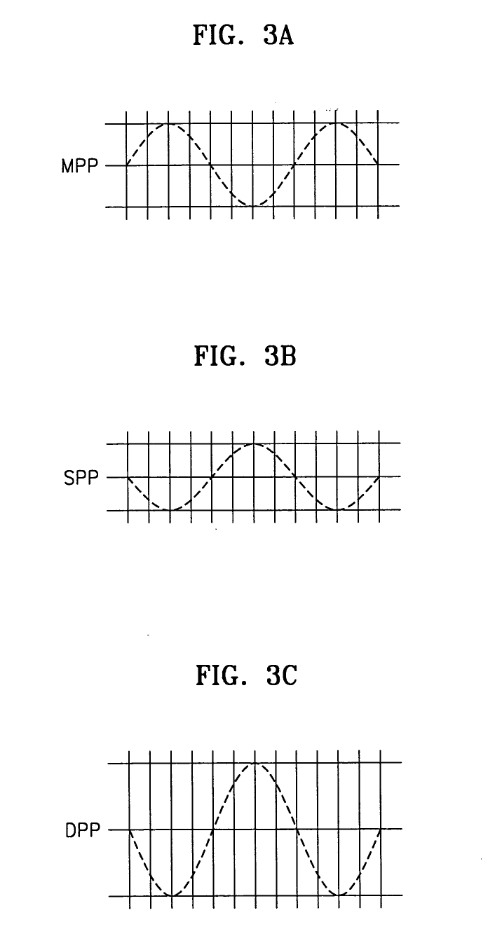

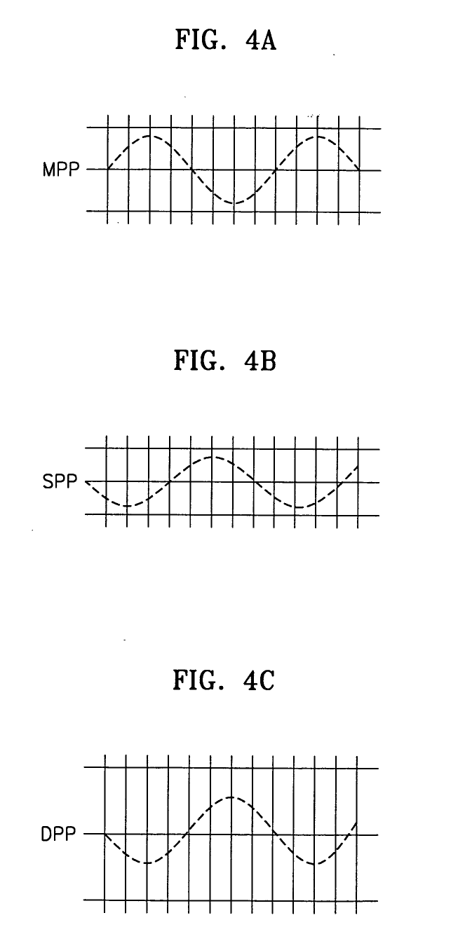

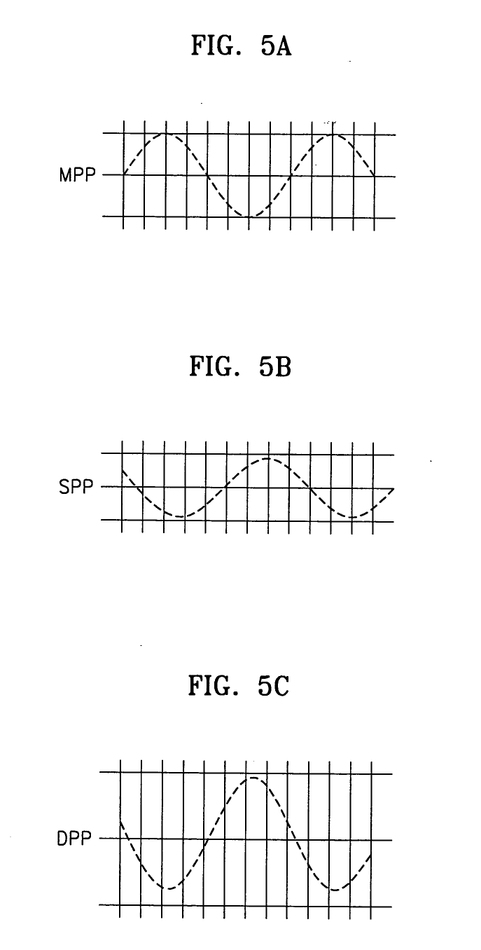

Conventionally, as shown in FIGS. 3 through 5, a change in a disc track pitch results in a change in the amplitude of an AC component waveform of an SPP signal, thereby preventing stable generation of a DPP signal. However, according to the embodiment of the present invention, AC components are removed from the SPP signal and, as a result, a DPP signal can be stably generated regardless of a disc track pitch.

Referring to FIG. 1A, photodetecting units PD_{A}, PD_{B}, PD_{C}, and PD_{D} are arranged at four quadrants in a clockwise direction and the photodetecting units PD_{A} and PD_{D}, are arranged to be symmetrical with the photodetecting units PD_{B} and PD_{C} with respect to a specific track. If electrical signals detected by the photodetecting units PD_{A}, PD_{B}, PD_{C}, and PD_{D} are a, b, c, and d, the MPP signal generating unit 701 calculates a signal (a+d)−(b+c) to generate an MPP signal and the SPP signal generating unit 702 calculates a signal (a+c)−(b+d) to generate an SPP signal. In this case, since the filter 703 removes AC components from the SPP signal, a DPP signal can be stably produced even if a disc track pitch is changed.

Accordingly, according to an embodiment of the present invention, it is possible to stably generate a tracking error signal (or a DPP signal) and stably perform tracking servo control, regardless of a change in a disc track pitch. In other words, a tracking error signal generating unit according to the present invention is capable of stably generating a tracking error signal on DVDs and CDs with different disc track pitches.

As described above, according to an embodiment of the present invention, a filter is built in a tracking error signal generating circuit that generates a tracking error signal using a DPP method so as to remove AC components from an SPP signal. Therefore, a tracking error signal can be stably generated regardless of a disc track pitch.

Embodiments of the present invention include a method, an apparatus, and a system. A program or code segments may be stored in a processor-readable medium or may be transmitted via a transmitting apparatus or network in response to a computer data signal that is combined with a carrier wave. Here, the processor-readable medium may be any medium capable of storing or transmitting data, e.g., an electronic circuit, a semiconductor memory device, a ROM, a flash memory, an EE PROM, a floppy disk, an optical disc, a hard disc, an optical fiber medium, or a radio-frequency (RF) net. Also, the computer data signal may be any signal that can be transmitted over a transmission medium such as an electronic net channel, an optical fiber, air, an electric field, or an RF net.

Although a few embodiments of the present invention have been shown and described, the present invention is not limited to the disclosed embodiments. Rather, it would be appreciated by those skilled in the art that changes may be made in this embodiment without departing from the principles and spirit of the invention, the scope of which is defined by the claims and their equivalents.

What is claimed is:

1. A tracking error signal generating apparatus comprising:
a main beam push pull (MPP) signal generating unit which generates an MPP signal according to electrical signals output by main photodetecting units based on a calculated deviation of beam powers detected by the main photodetecting units arranged on right and left sides of a specific track, respectively;
a side beam push pull (SPP) signal generating unit which generates an SPP signal according to electrical signals output by photodetecting units based on a calculated deviation of beam powers detected by the photodetecting units, the photdetecting units being one of pairs of the main photodetecting units diagonally arranged with respect to the track and side photodetecting units disposed on opposing sides of the track and outside of the main photdetecting units;
a filter which removes AC components from the SPP signal; and
a subtractor which generates a tracking error signal by calculating a difference between the MPP signal and the filtered SPP signal.

2. The apparatus of claim 1, wherein the MPP signal generating unit generates the MPP signal by performing an operation on electrical signals a, b, c, and d which satisfies an equation MPP=(a+d)−(b+c) and the SPP signal generating unit generates the SPP signal by performing an operation on the electrical signals a, b, c, and d which satisfies an equation SPP=(a+c)−(b+d), wherein the main photodetecting units comprise main photodetecting units PD_{A}, PD_{B}, PD_{C}, and PD_{D} which respectively output the electrical signals a, b, c, and d, wherein the main photodetecting units PD_{A}, PD_{B}, PD_{C}, and PD_{D} are positioned at four quadrants in a clockwise direction, and wherein the main photodetecting units PD_{A} and PD_{D} are symmetrically arranged with the main photodetecting units PD_{B} and PD_{C} with respect to the track.

3. The apparatus of claim 1, wherein the MPP signal generating unit generates an MPP signal by performing an operation on electrical signals a, b, c, and d which satisfies an equation MPP=(a+d)−(b+c) and the SPP signal generating unit generates an SPP signal by performing an operation on electrical signals e and f which satisfies an equation SPP=(e−f), wherein the main photodetecting units comprise main photodetecting units PD_{A}, PD_{B}, PD_{C}, and PD_{D} which respectively output the electrical signals a, b, c, and d, wherein the main phtodetecting units PD_{A}, PD_{B}, PD_{C}, and PD_{D} are positioned at four quadrants in a clockwise direction, wherein the main photodetecting units PD_{A} and PD_{D} are symmetrically arranged with the main photodetecting units PD_{B} and PD_{C} with respect to the track, wherein the side photodetectors comprise side photodetecting units PD_{E} and PD_{F} which respectively output electrical signals e and f, and wherein the side photodetecting units PD_{E} and PD_{F} are symmetrically arranged at opposing sides of the track and outside of the main photodetecting units PD_{A}, PD_{B}, PD_{C}, and PD_{D}.

4. A method of generating a tracking error signal comprising:
calculating a difference between an MPP signal and an SPP signal whose AC components are removed,
wherein the MPP signal is obtained by calculating a deviation of beam powers detected by main photodetecting units which are arranged in right and left directions with respect to a track and the SPP signal is obtained by calculating a deviation of beam powers detected by photodetecting units which are one of pairs of the main photodetectors diagonally arranged with respect to the track and side photodecting units disposed on opposing sides of the track and outside of the main photodetecting units.

5. The method of claim 4, wherein the MPP signal is obtained by performing an operation on electrical signals a, b, c, and d which satisfies an equation MPP=(a+d)−(b+c) and the SPP signal generating unit generates the SPP signal by performing an operation on the electrical signals a, b, c, and d which satisfies an equation SPP=(a+c)−(b+d), wherein the main photodetecting units comprise main photodetecting units PD_{A}, PD_{B}, PD_{C}, and PD_{D} which respectively output the electrical signals a, b, c, and d, wherein the main photodetecting units PD_{A}, PD_{B}, PD_{C}, and PD_{D} are positioned at four quadrants in a clockwise direction, and wherein the main photodetecting units PD_{A} and PD_{D} are symmetrically arranged with the main photodetecting units PD_{B} and PD_{C} with respect to the track.

6. The method of claim 4, wherein the MPP signal is obtained by performing an operation on electrical signals a, b, c, and d which satisfies an equation MPP=(a+d)−(b+c) and the SPP signal generating unit generates an SPP signal by performing an operation on electrical signals e and f which satisfies an equation SPP=(e−f), wherein the main photodetecting units comprise main photodetecting units PD_{A}, PD_{B}, PD_{C}, and PD_{D} which respectively output the electrical signals a, b, c, and d, wherein the main phtodetecting units PD_{A}, PD_{B}, PD_{C}, and PD_{D} are positioned at four quadrants in a clockwise direction, wherein the main photodetecting units PD_{A} and PD_{D} are symmetrically arranged with the main photodetecting units PD_{B} and PD_{C} with respect to the track, wherein the side photodetectors comprise side photodetecting units PD_{E} and PD_{F} which respectively output electrical signals e and f, and wherein the side photodetecting units PD_{E} and PD_{F} are symmetrically arranged at opposing sides of the track and outside of the main photodetecting units PD_{A}, PD_{B}, PD_{C}, and PD_{D}.

7. An optical recording/reproducing system, comprising:
a pickup which emits a laser beam toward an optical medium and detects a reflected laser beam reflected from a disc;
a tracking error signal generating unit that generates a tracking error signal by calculating a difference between an MPP signal obtained by calculating a deviation of beam powers detected by main photodetecting units which are arranged in right and left directions with respect to a track and an SPP signal obtained by calculating a deviation of beam powers detected by photodetecting units which are one of main photodetecting units diagonally arranged with respect to the track and signals output by side photodetecting units disposed on opposing sides of the main photodetectors;
a servo controller which generates a tracking driving signal which is used to move an optical system of the pickup in a radial direction so as to direct the laser beam at a center of the track, using the tracking error signal; and
a tracking servo driving unit which drives a tracking actuator included in the pickup in response to the tracking driving signal.

8. The system of claim 7, wherein the MPP signal is obtained by performing an operation on electrical signals a, b, c, and d which satisfies an equation MPP=(a+d)−(b+c) and the SPP signal generating unit generates the SPP signal by performing an operation on the electrical signals a, b, c, and d which satisfies an equation SPP=(a+c)−(b+d), wherein the main photodetecting units comprise main photodetecting units PD_{A}, PD_{B}, PD_{C}, and PD_{D} which respectively output the electrical signals a, b, c, and d, wherein the main photodetecting units PD_{A}, PD_{B}, PD_{C}, and PD_{D} are positioned at four quadrants in a clockwise direction, and wherein the main photodetecting units PD_{A} and PD_{D} are symmetrically arranged with the main photodetecting units PD_{B} and PD_{C} with respect to the track.

9. The system of claim 7, wherein the MPP signal is obtained by performing an operation on electrical signals a, b, c, and d which satisfies an equation MPP=(a+d)−(b+c) and the SPP signal generating unit generates an SPP signal by performing an operation on electrical signals e and f which satisfies an equation SPP=(e−f), wherein the main photodetecting units comprise main photodetecting units PD_{A}, PD_{B}, PD_{C}, and PD_{D} which respectively output the electrical signals a, b, c, and d, wherein the main phtodetecting units PD_{A}, PD_{B}, PD_{C}, and PD_{D} are positioned at four quadrants in a clockwise direction, wherein the main photodetecting units PD_{A} and PD_{D} are symmetrically arranged with the main photodetecting units PD_{B} and PD_{C} with respect to the track, wherein the side photodetectors comprise side photodetecting units PD_{E} and PD_{F} which respectively output electrical signals e and f, and wherein the side photodetecting units PD_{E} and PD_{F} are symmetrically arranged at opposing sides of the track and outside of the main photodetecting units PD_{A}, PD_{B}, PD_{C}, and PD_{D}.

10. A computer readable medium encoded with processing instructions for implementing a method of generating a tracking error signal, the method comprising:
calculating a difference between an MPP signal and an SPP signal whose AC components are removed, wherein the MPP signal is obtained by calculating a deviation of beam powers detected by main photodetecting units which are arranged in right and left directions with respect to a track and the SPP signal is obtained by calculating a deviation of beam powers detected by photodetecting units which are one of pairs of the main photodetectors diagonally arranged with respect to the track and side photodecting units disposed on opposing sides of the track and outside of the main photodetecting units.

11. A tracking error signal generator comprising:
a main push pull (MPP) signal generator which generates an MPP signal based on a difference between a first sum signal representing the sum of signals output from main photodetecting portions disposed on a side of a track and a second sum signal representing the sum of signals output by the main photodetecting portions disposed on an opposing side of the track;
a side push pull (SPP) signal generator which generates an SPP signal based on a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a fifth signal output by a first side photodetector and a sixth signal output by a second side photodetector;
a filter which removes one or more AC components from the SPP signal; and
a subtractor which generates a tracking error signal based on a difference between the MPP signal and a filtered SPP signal.

12. The tracking error signal generator of claim 11, wherein the main photodetecting portions are positioned at four quadrants of a photodetector in a clockwise direction and the main photodetecting portions on the first side of the track are symmetrically arranged with the main photodetecting portions on the opposing side of the track.

13. The tracking error signal generator of claim 11, wherein the side photodectors are disposed at opposing sides of the track and outside of the main photodetectors

14. A method of generating a tracking error signal, comprising:
generating a main push pull (MPP) signal based on a difference between a first sum signal representing the sum of signals output from main photodetecting portions disposed on a side of a track and a second sum signal representing the sum of signals output by the main photodetecting portions disposed on an opposing side of the track;
generating a side push pull (SPP) signal based on a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a firth sum signal output by a first side photodetector and a sixth sum signal output by a second side photodetector;
removing one or more AC components from the SPP signal; and
generating a tracking error signal based on a difference between the MPP signal and a filtered SPP signal.

15. The method of claim 14, wherein the main photodetecting portions are positioned at four quadrants of a photodetector in a clockwise direction and the main photodetecting portions on the first side of the track are symmetrically arranged with the main photodetecting portions on the opposing side of the track.

16. The method of claim 14, wherein the side photodectors are disposed at opposing sides of the track and outside of the main photodetectors.

17. A computer readable medium encoded with processing instructions for implementing a method of generating a tracking error signal, the method comprising:
generating a main push pull (MPP) signal based on a difference between a first sum signal representing the sum of signals output from main photodetecting portions disposed on a side of a track and a second sum signal representing the sum of signals output by the main photodetecting portions disposed on an opposing side of the track;
generating a side push pull (SPP) based on a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a firth sum signal output by a first side photodetector and a sixth sum signal output by a second side photodetector;
removing one or more AC components from the SPP signal; and
generating a tracking error signal based on a difference between the MPP signal and a filtered SPP signal.

18. The computer readable medium of claim 17, wherein the main photodetecting portions are positioned at four quadrants of a photodetector in a clockwise direction and the main photodetecting portions on the first side of the track are symmetrically arranged with the main photodetecting portions on the opposing side of the track.

19. The computer readable medium of claim 17, wherein the side photodectors are disposed at opposing sides of the track and outside of the main photodetectors.

20. An optical recording/reproducing system, comprising:
a pickup having a light beam generator which generates a light beam, an optical system which focuses the light beam onto an optical medium, a focus/tracking actuator which moves the optical system in a radial direction with respect to the optical medium in response to a tracking driving signal so as to direct the light beam at a specific track on the optical medium, and a photodetector section including main photodetecting portions which receive the light beam after the light beam is reflected from the optical medium and output respective signals in response thereto;
a tracking error signal generator which generates a tracking error signal representing a difference between a main push pull (MPP) signal and a side push pull (SPP) generator;
a servo controller which generates the tracking driving signal based on the tracking error signal,
wherein the MPP signal is generated based on a difference between a first sum signal representing the sum of signals output from the main photodetecting portions disposed on a side of a track and a second sum signal representing the sum of signals output by the main photodetecting portions disposed on an opposing side of the track, and
wherein the SPP signal is generated based on a difference between one of a third sum signal representing the sum of signals output from the main photodetecting portions which are diagonally disposed with respect to the track in a first direction and a fourth sum signal representing the sum of signals output by the main photodetecting portions diagonally disposed with respect to the track in a second direction normal to the first and a fifth signal output by a first side photodetector and a sixth signal output by a second side photodetector.

21. The optical recording/reproducing system of claim 20, wherein the main photodetecting portions are positioned at four quadrants of a photodetector in a clockwise direction and the main photodetecting portions on the first side of the track are symmetrically arranged with the main photodetecting portions on the opposing side of the track.

22. The optical recording/reproducing system of claim 20, wherein the side photodectors are disposed at opposing sides of the track and outside of the main photodetectors.

23. A filter in a tracking error signal generating circuit which generates a tracking error signal using a differential push pull method, comprising:
an AC component remover which removes one or more AC components from a side beam push pull (SPP) signal, wherein the SPP signal is obtained by using electrical signals output by photodetecting units based on a calculated deviation of beam powers detected by the photodetecting units, the photodetecting units being one of pairs of the main photodetecting units diagonally arranged with respect to the track and side photodetecting units disposed on opposing sides of the track and outside of the main photdetecting units, and
wherein the tracking error signal can be stably generated regardless of a disc track pitch.
